(19) United States
(12) Patent Application Publication
(10) Pub. No.: US 2007/0254651 A1
(43) Pub. Date: Nov. 1, 2007

(54) Digital Broadcast Receiver

(76) Inventor: Miyuki Sasaki, Osaka (JP)

Correspondence Address: MARK D. SARALINO (MEI);RENNER, OTTO, BOISSELLE & SKLAR, LLP, 1621 EUCLID AVENUE, 19TH FLOOR, CLEVELAND, OH, 44115, US

(21) Appl. No.: 11/720,199

(22) PCT Filed: Dec. 21, 2005
(86) PCT No.: PCT/JP05/23474

§ 371 Date: May 25, 2007

(30) Foreign Application Priority Data
Dec. 21, 2004 (JP) 2004-369349

(51) Int. Cl. H04Q 7/20

(52) U.S. Cl. 455/435.1

(57) ABSTRACT

To provide the technique of getting a content that is executable on a mobile terminal without using the mobile terminal to access the responding server of a content seller. A digital broadcast receiver transmits content data to at least one external terminal with a unique terminal ID. The receiver includes: a receiving section for receiving a digital broadcasting wave; a getting section for getting the content data from the digital broadcasting wave; a memory in which the terminal IDs of one or more external terminals have been stored in advance; and a communication section for communicating with the external terminal and getting the unique terminal ID of the external terminal. If the terminal ID gotten is identical to any of the terminal IDs stored in the memory, the communication section transmits the content data to the external terminal.

### TECHNICAL FIELD

The present invention relates to a technique of getting a content. More particularly, the present invention relates to the technique of getting a content, which the user has agreed to pay for over a telecommunications line, by digital broadcast data communications and making it available on a mobile terminal.

### BACKGROUND ART

Various types of digital broadcasting, which have been getting more and more popular these days, have not only channels for transmitting TV programs (including video and audio) from the broadcaster to the viewer but also channels for transmitting only TV program related data or even independent data that have nothing to do with TV programs (which are called “data channels”). Those data channels transmit characters, still pictures and other kinds of data.

Meanwhile, content providing services utilizing digital broadcasting have also become a commonplace recently. This type of service is provided by a content seller, who places an ad of a content, along with their own website address (URL), on a digital broadcasting data channel and provides that content to the viewer who has accessed the site using a mobile terminal. When the user of the mobile terminal has settled a bill for that content with the content seller using his or her mobile terminal, he or she can get any desired content on his or her own mobile terminal.

FIG. 8 shows a configuration for a content providing system that utilizes digital broadcasting. In this system, the content provided is supposed to be a game to be viewed or played on a mobile terminal such as a cellphone. The content providing system includes a digital broadcast receiver 701, a mobile terminal 702, a broadcaster 703 and a content seller 704.

The digital broadcast receiver 701 (which will be simply referred to herein as a “receiver 701”) has the function of receiving a broadcasting wave such as a digital broadcast from the broadcaster 703 and the function of transmitting and receiving data to/from the content seller 704 over a telecommunications line (such as the Internet) compliant with some standard protocol (such as HTTP (hyper text transfer protocol)). The mobile terminal 702 has not only a normal calling function but also the function of transmitting and receiving data to/from the content seller 704.

The content seller 704 (which will be simply referred to herein as a “seller 704”) includes a responding server 123 that responds to an access from the mobile terminal 702, an authenticating section 722 for authenticating the mobile terminal 702, a settlement system 121 for inquiring a mobile carrier about the authenticated mobile terminal 702, determining a method of settlement and billing the user, and a content database 721 in which various contents are bound-recorded.

The receiver 701 receives a digital broadcasting wave from the broadcaster 703 to acquire video and audio data from the channel of a program. In addition, the receiver 701 also receives data that has been sent out about that program on a data channel (e.g., the address of the responding server 123 of the content seller 704).

By manipulating the remote controller (not shown) of the receiver 701 while watching and listening to the program, the viewer can know the address of the responding server 123. Then, he or she accesses the responding server 123 of the content seller 704 by entering the address gotten into his or her mobile terminal 702, thereby transmitting his or her personal information, including his or her name, address and phone number, to the responding server 123. In response, the seller 704 authenticates the viewer by reference to his or her personal information, thereby performing purchasing and settlement processing on the user's selected content. This content may be formatted for a mobile terminal, i.e., so as to have a screen size and a data size that have been appropriately set to present it on the mobile terminal. The charge for the content is usually added to the telecommunications fee of the mobile terminal 702. Optionally, the user may also pay for the content by credit card (i.e., by entering the number of his or her credit card). When the settlement processing is done, the viewer can download the content to his mobile terminal 702 and enjoy it.

The viewer can also access the seller 704 by entering the gotten address of the responding server 123 into the receiver 701. In that case, the viewer transmits his or her personal information to the seller 704 by using the receiver 701. After that, the viewer accesses the responding server again using the mobile terminal 702, gets authenticated, and then gets content downloaded. As a result, the viewer can enjoy the content on his or her own mobile terminal.
Patent Document No. 1: Japanese Patent Application Laid-Open Publication No. 2003-209542

### DISCLOSURE OF INVENTION

### Problems to be Solved by the Invention

According to the conventional content providing system, however, the viewer must access the content seller using his or her mobile terminal. That is why he or she has to go through time-consuming jobs of address entering and payment process by using a mobile terminal, which is not always easy to handle when it comes to entering required information. What is more, the viewer must get connected to the Internet a number of times using the digital broadcast receiver and the mobile terminal. And he or she has to pay the service fee or telecommunications fee every time he or she gets connected.

Thus, an object of the present invention is to get a content to enjoy on a mobile terminal without using the mobile terminal to access the responding server of that content seller.

### MEANS FOR SOLVING THE PROBLEMS

A digital broadcast receiver according to the present invention transmits content data to at least one external terminal with a unique terminal ID. The receiver includes: a receiving section for receiving a digital broadcasting wave; a getting section for getting the content data from the digital broadcasting wave; a memory in which the terminal IDs of one or more external terminals have been stored in advance; and a communication section for communicating with the external terminal and getting the unique terminal ID of the external terminal. If the terminal ID gotten is identical to any of the terminal IDs stored in the memory, the communication section transmits the content data to the external terminal.

If the terminal ID gotten is not identical to any of the terminal IDs stored in the memory, the communication section may control the transmission of the content to the external terminal.

The memory may store a content ID that identifies a transmittable content in association with the terminal ID of each of the one or more external terminals. The communication section may get the terminal ID of the external terminal on the receiving end before transmitting the content thereto. And if the content ID of the content to be transmitted and the terminal ID are associated with each other in the memory, the communication section may transmit the content to the external terminal.

If the content ID of the content to be transmitted and the terminal ID are not associated with each other in the memory, the communication section may control the transmission of the content to the external terminal.

The digital broadcast receiver may further include: a network communicating section for communicating with a server of the seller of the content; and a decrypting section for decrypting an encrypted content. The network communicating section may transmit contract information, which has been entered by a user, to the server and may receive key data to decode the content from the server. The key data has been provided based on the contract information. The getting section may get encrypted content data. And the decrypting section may decrypt the encrypted content with the key data.

The getting section may get the content from the digital broadcasting wave by reference to the content ID of the content that the user has agreed to purchase.

The digital broadcast receiver may further include a network communicating section for communicating with a server of the seller of the content. The communication section may receive the content related information from the external terminal. And the network communicating section may transmit the received information to the server.

If the terminal ID gotten is identical to any of the terminal IDs stored in the memory, the communication section may receive the information from the external terminal.

If the content ID of the content, about which the information has been provided, and the terminal ID are further associated with each other in the memory, the communication section may receive the information from the external terminal.

### EFFECTS OF THE INVENTION

According to the present invention, an authentication process for allowing the viewer to purchase and pay for his or her selected content is performed on a digital broadcast receiver. Thus, he or she can get the content to enjoy on a digital broadcast receiver or a mobile terminal by using the digital broadcast receiver. This means that the viewer can promptly get a content, which he or she was inclined to buy when looking at an ad on a data broadcast, just by operating the digital broadcast receiver. Consequently, there is no need for him or her to get the content using a mobile terminal, which is not always easy to handle.

Besides, the content that has been gotten using the digital broadcast receiver can be downloaded to a mobile terminal by utilizing the function of establishing bidirectional communications with the mobile terminal. As a result, the viewer can get the content with his or her mobile terminal without paying telecommunications fees or making time-consuming operations.

### BRIEF DESCRIPTION OF DRAWINGS

FIG. 1 shows a configuration for a content providing system according to a preferred embodiment of the present invention.

FIG. 2 shows an arrangement of functional blocks for a digital broadcast receiver 101 according to a preferred embodiment of the present invention.

FIG. 3 is a flowchart showing how to get and execute a content using the digital broadcast receiver 101.

FIG. 4 shows another exemplary table of correspondence between mobile terminal ID numbers and device ID numbers.

FIG. 5 is a flowchart showing the procedure of transmitting a content, which has been gotten by the digital broadcast receiver 101, to a mobile terminal 102.

FIG. 6 shows a configuration for a modified content providing system.

FIG. 7 shows a table of correspondence that was compiled and retained in the device ID authenticating section 122.

FIG. 8 shows a configuration for a content providing system that uses a digital broadcasting.

### DESCRIPTION OF REFERENCE NUMERALS

101 digital broadcast receiver
102 mobile terminal
103 broadcaster
104 content seller

### BEST MODE FOR CARRYING OUT THE INVENTION

Hereinafter, a preferred embodiment of a content providing system according to the present invention will be described with reference to the accompanying drawings.

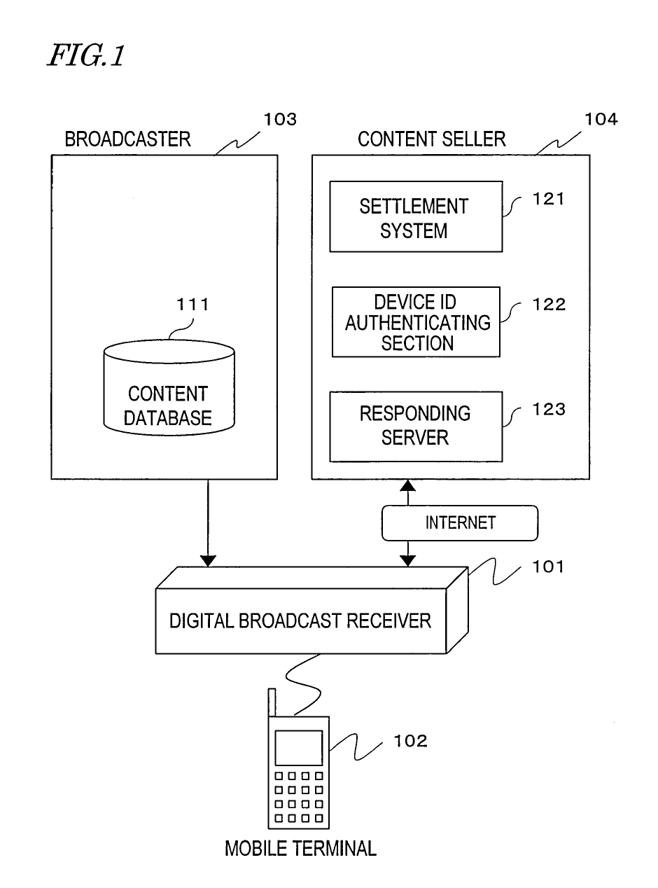

FIG. 1 shows a configuration for a content providing system according to a preferred embodiment of the present invention. The content providing system includes a digital broadcast receiver 101, a mobile terminal 102, a broadcaster 103 and a content seller 104.

In this content providing system, the content seller 104 (which will be simply referred to herein as the “seller 104”) shows the lineup of its own contents to the viewer (or user) using data broadcasting that is linked to digital broadcasting, and provides a content, which the user has agreed to pay for, to the user.

In this preferred embodiment, the “content” is supposed to be a game that can be played on a mobile terminal such as a cellphone or a personal digital assistant (PDA) or on a digital broadcast receiver. However, this is just an example. Therefore, not just games but also moving pictures with audio (e.g., a TV program), character information and an application to do schedule management may be handled as contents.

The digital broadcast receiver 101 (which will be simply referred to herein as the “receiver 101”) is installed at a user's home to receive the broadcast waves of digital broadcasting (including data broadcasting) from the broadcaster. In addition, the receiver 101 can also transmit and receive data to/from the seller 104 over a telecommunications lines such as the Internet.

The receiver 101 and the mobile terminal 102 can transmit and receive data to/from each other. As will be described later, it is content data (e.g., the game's program) that should be exchanged. In the following description, even “content data” will be referred to as just a “content”.

The broadcaster 103 owns a content database 111 and sends out any of the contents that are bound-recorded in the content database 111 over the digital broadcasting or its linked data channel. This is one of the major differences from the conventional system in which the content seller owns the content database.

The seller 104 not only provides contents for the broadcaster 103 but also makes the broadcaster 103 fulfill a contract to transmit those contents at specified dates and times and for a predetermined period of time over the data channel of the digital broadcasting. The broadcaster 103 receives the contents from the seller 104 and stores them in the content database 111.

The seller 104 includes a settlement system 121, a device ID authenticating section 122 and a responding server 123. The settlement system 121 inquires a mobile carrier about the authenticated device, determines an appropriate method of settlement and bills the user of the device. The device ID authenticating section 122 is provided to authenticate the receiver 101. More specifically, the device ID authenticating section 122 authenticates the digital broadcast receiver 101 by its own unique ID number (i.e., the device ID). The responding server 123 is a WWW server responding to external accesses and provides an interface during the settlement process or the process of authenticating the device.

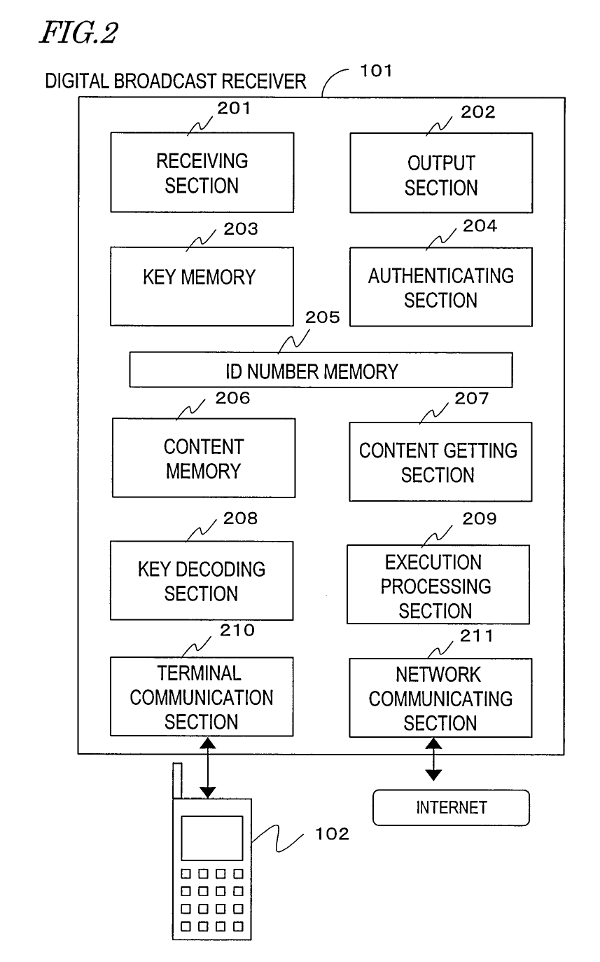

FIG. 2 shows an arrangement of functional blocks for the receiver 101 of this preferred embodiment. The receiver 101 includes a receiving section 201, an output section 202, a key memory 203, an authenticating section 204, an ID number memory 205, a content memory 206, a content getting section 207, a key decoding section 208, an execution processing section 209, a terminal communication section 210 and a network communicating section 211.

Hereinafter, the functions of the respective components will be described one by one. The receiving section 201 receives a digital broadcast including video, audio and a data broadcast. The output section 202 presents the digital broadcast on a display, for example. The key memory 203 stores content key information to get and execute a content such as a game for decoding purposes. In addition, the key memory 203 also stores the content IDs. The authenticating section 204 sends a device ID, the user's personal information (to be described later) and so on to the seller 104 to get the content key information from the seller 104.

The ID number memory 205 retains mobile terminal ID numbers. As used herein, the “mobile terminal ID number” is a unique number given to each and every mobile terminal. The ID number memory 205 also retains its own device ID number.

The content memory 206 stores the gotten contents. The content getting section 207 gets a content from the digital broadcasting. The key decoding section 208 decodes the gotten content with a content key and makes it executable. The execution processing section 209 executes the content. The terminal communication section 210 makes bidirectional communications with a mobile terminal. And the network communicating section 211 communicates with the responding server 123 of the seller and other devices with a telecommunication function over the Internet.

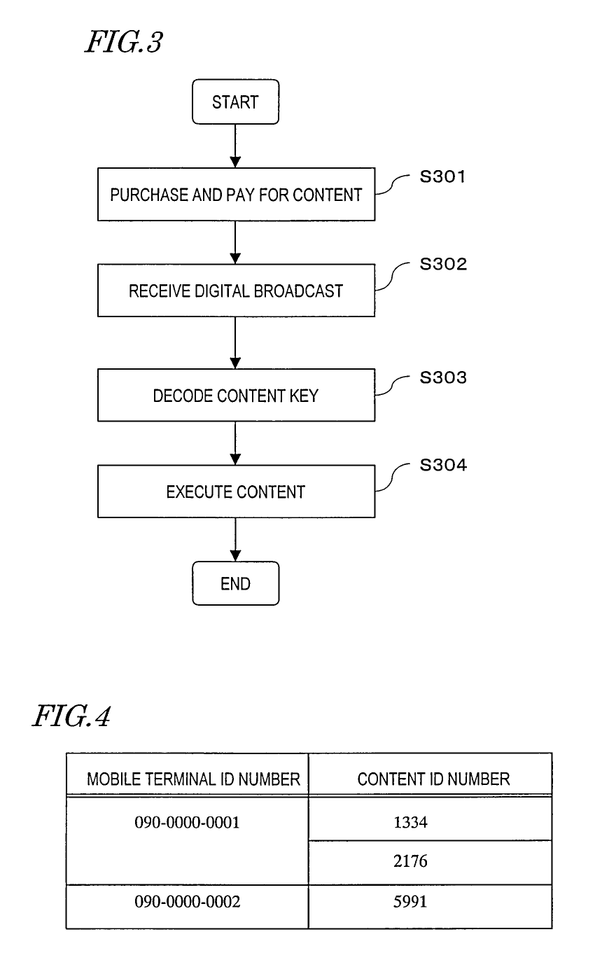

Next, it will be described with reference to FIG. 3 how the receiver 101 gets a content for the mobile terminal 102. In the following example, the user is supposed to purchase a content, which is included in the list shown in the digital broadcast (i.e., data broadcast), by manipulating buttons on the body of the receiver 101 or the remote controller (not shown) thereof.

FIG. 3 shows how the receiver 101 gets and executes a content. First, in Step S301, content purchasing and settlement processing is carried out. More specifically, first, the authenticating section 204 communicates with the seller 104 over the Internet. Meanwhile, the user enters his or her personal information, including his or her own address, name and phone number, which is required to purchase a content, by using the remote controller.

The authenticating section 204 sends not only these pieces of information but also its own device ID number, which is stored in the ID number memory 205, to the seller 104. On authenticating the user and the device successfully, the seller 104 transmits the content ID and the content key of the content requested to the receiver 101. In response, the authenticating section 204 stores this content ID and content key in the key memory 203.

It should be noted that if the user has entered his or her mobile terminal ID number as a piece of personal information, then the authenticating section 204 may store a table of correspondence between the mobile terminal ID numbers and the contents' ID numbers in the key memory 203. FIG. 4 shows an exemplary table of correspondence stored in the key memory 203. By retaining such a table of correspondence, it is possible to prevent other users of the receiver 101 from downloading the content to their mobile terminals without getting the content copyright holder's consent. In the example illustrated in FIG. 4, the content identified by the content ID number 1334 is never downloaded from the receiver 101 to anybody but the mobile terminal identified by the mobile terminal ID number 090-000-0001. That is why another user having a mobile terminal identified by the mobile terminal ID number 090-000-0002 can never get the content downloaded to his or her mobile terminal. Only the content identified by the content ID number 5991 can be downloaded to the latter's mobile terminal. If only device ID numbers were used, it would be impossible to identify any mobile terminal that is going to use the content. For that reason, this method using a table of correspondence is preferred.

Next, in Step S302, the content getting section 207 gets the target content from the digital broadcast, received by the receiving section 201, by reference to the content ID that is stored in the key memory 203.

More specifically, the content getting processing is carried out in the following manner. The digital broadcast is transmitted as an MPEG-2 transport stream consisting of a plurality of TS packets. And those TS packets have been given different identifiers (i.e., packet IDs) to identify the smallest units such as broadcast programs and data programs. For example, if a content such as a game program has been transmitted as a section consisting of multiple packets, a section ID may be used as the content ID stored in the key memory 203. The content getting section 207 extracts a group of TS packets with that section ID from the digital broadcast received, thereby getting the as-transmitted content. As used herein, the “as-transmitted content” refers to a content that is still encrypted. The content getting section 207 stores the content just gotten in the content memory 206 as it is (i.e., still in the encrypted form).

Optionally, the getting processing may be carried out in different ways, too. For example, a digital broadcast stream is given an information ID showing the type (or category) of the information being transmitted. That information ID is written in the Info descriptor field in the DDI (Download Info Indication) message in the stream. The content getting section 207 refers to the Info descriptor field of the digital broadcast received to determine whether or not the information ID showing a game content has been added. If the information ID has been detected, then the content getting section 207 determines whether or not the content ID stored in the key memory 203 is included in the data of the digital broadcast received. If the answer is YES, it means that the data being received is the content purchased. Thus, the content getting section 207 gets the content and stores it in the content memory 206. It should be noted that this content is still encrypted, too.

The content may be encrypted by a secret key method, which is often adopted generally. This method is characterized in that the key used for encryption is the same as the key used for decoding. Alternatively, an open key method or any other method may be adopted as well.

Next, in Step S303, the key decoding section 208 decrypts and decodes the content, which is stored in the content memory 206 and is still encrypted, with the content key stored in the key memory 203 for decoding purposes.

Finally, in Step S304, the execution processing section 209 executes the content and gets the content presented on the display screen by the output section 202. As a result, the viewer can enjoy the content (such as a game) by using a remote controller, for example.

It should be noted that a Java virtual machine that executes a program Java™ with little device dependence has been installed in this execution processing section 209. Thus, the same content (i.e., a Java program) can be executed by the mobile terminal 102 and by the execution processing section 209. As a result, as in the mobile terminal, the game can also be played even on a display connected to the receiver 101.

As described above, the receiver 101 of this preferred embodiment can not only purchase a content that is mentioned or advertised on a data broadcast associated with the digital broadcast but also get and execute the content. Thus, there is no need for the viewer to access the content seller 104 by using his or her mobile terminal 102. Consequently, he or she no longer has to do those time-consuming input operations with the mobile terminal and never has to pay telecommunications fees for using the mobile terminal 102 for that purpose.

In the preferred embodiment described above, a Java virtual machine is supposed to be installed. Alternatively, any other virtual machine that can execute a non-Java program may be installed, too. In any case, as long as the program can be executed as in the mobile terminal 102 described above, similar effects are also achieved.

Also, in the preferred embodiment described above, the receiver 101 is supposed to automatically add its device ID number to the data transmitted to the seller 104. However, the ID number may also be entered by the viewer using an input section such as a remote controller. In that case, if a plurality of devices that can execute a content are connected together in a home, for example, other device IDs may also be entered.

Furthermore, in the preferred embodiment described above, every time a content needs to be executed, the content is supposed to be decrypted and decoded with a content key. Alternatively, as soon as a content has been gotten, the content may be decrypted and the resultant decoded content may be stored in the content memory 206. Then, a fewer number of processing steps need to be performed in executing a content and the execution time can be shortened.

In the content purchasing processing step S301, the mobile terminal ID number, name, address, device ID and other sorts of information that are required to purchase a content may be stored in advance in the ID number memory 205 of the receiver 101 after the user has bought the receiver 101 and while he or she is making initial settings such as channel setting. As another alternative, those pieces of information may also be stored in the ID number memory 205 when the user enters those sorts of information using a remote controller for purchasing and paying purposes. If the viewer gives an instruction to purchase a content using a remote controller, then the authenticating section 204 sends his or her instruction, along with those pre-stored pieces of information, to the seller 104. Optionally, those pieces of user information that are required to purchase a content may be provided for the seller 104 in advance. In that case, the authenticating section 204 may send the mobile terminal ID number and/or the device ID to the seller 104. By adopting any of these methods, the viewer can save the trouble to enter those pieces of information.

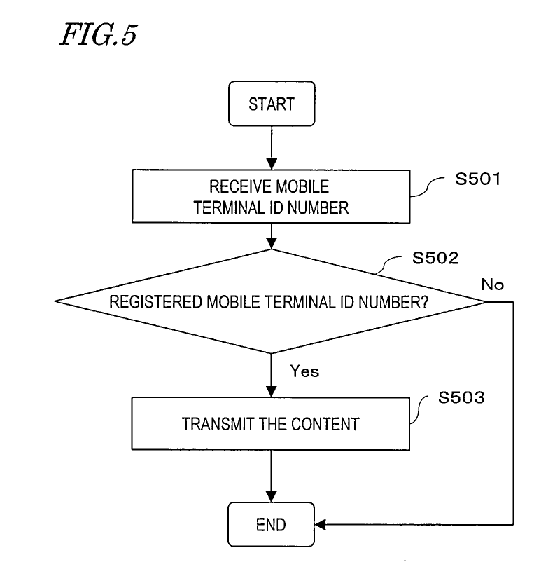

Hereinafter, it will be described with reference to FIG. 5 how the content that has been gotten by the receiver 101 should be transmitted to, or received from, the mobile terminal 102.

FIG. 5 shows the procedure of transmitting the content that has been gotten by the receiver 101 to the mobile terminal 102. First, in Step S501, the terminal communication section 210 of the receiver 101 gets the mobile terminal ID number from the mobile terminal 102. The mobile terminal ID number is gotten by using a dedicated application for use in communications between the mobile terminal 102 and the receiver 101. The mobile terminal ID number may be transmitted using the infrared communication function of the mobile terminal, for example.

The mobile terminal sends its own terminal ID number by using the dedicated application. The terminal communication section 210 may be provided as an infrared ray receiving section for the receiver 101 to receive the data that has been transmitted from the mobile terminal using an infrared ray. In this manner, the receiver 101 can get the mobile terminal ID number.

Next, in Step S502, the terminal communication section 210 determines, by reference to the ID number memory 205, whether or not the mobile terminal ID number gotten is a registered number.

If the answer to the query of Step S502 is NO, then the terminal communication section 210 regards the content as non-transmittable to end the processing. That is to say, the transmission of the content to that mobile terminal is prohibited. On the other hand, if the answer is YES, then the process advances to Step S503.

In Step S503, the terminal communication section 210 transmits the content, which is stored in the content memory 205, to the mobile terminal 102. As a result of these processing steps, the content can be gotten at the mobile terminal 102 without accessing the content seller 104 using the mobile terminal 102 and the user can enjoy the game content gotten on his or her own mobile terminal 102.

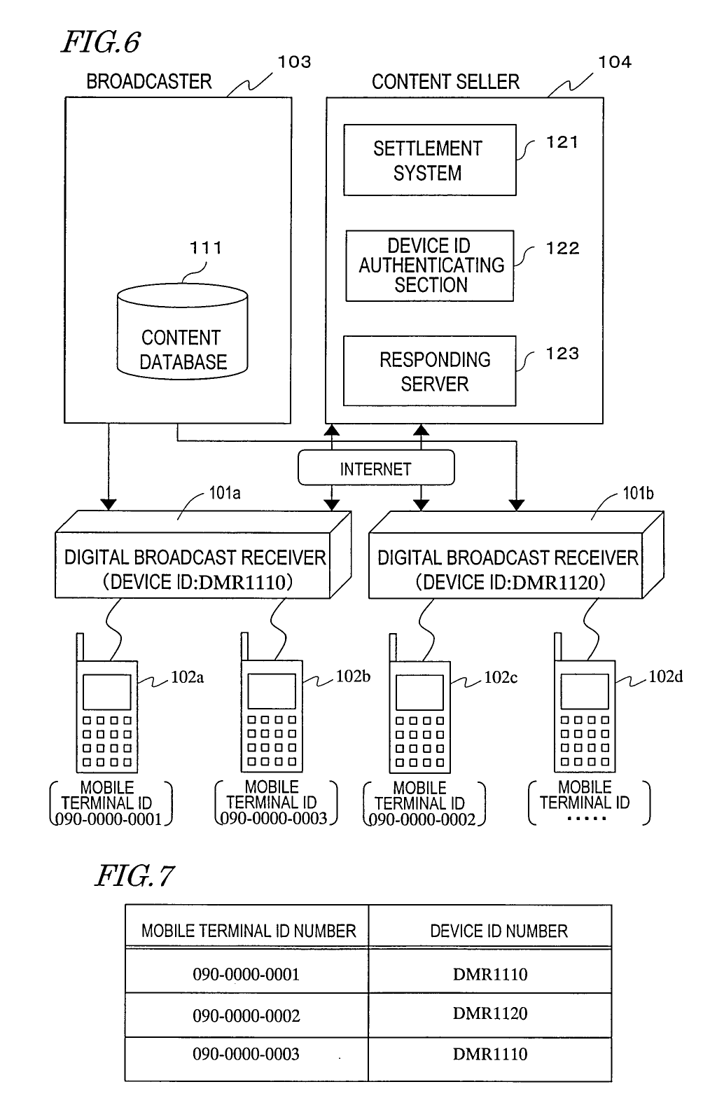

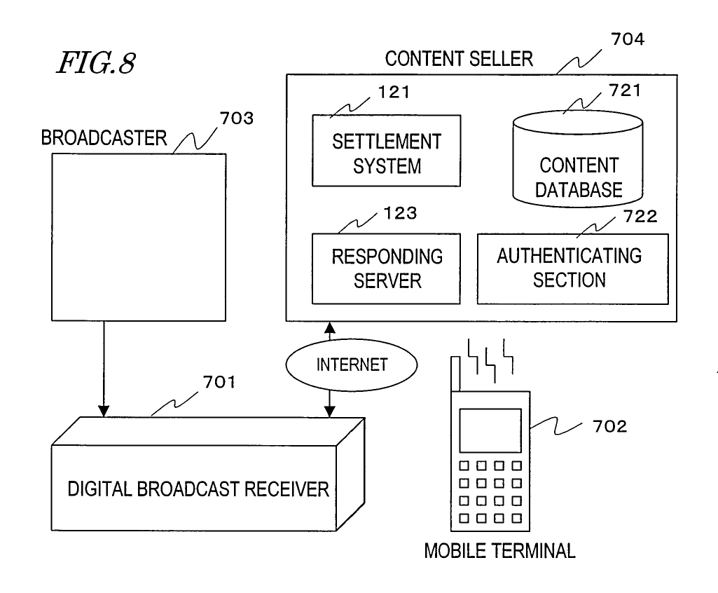

Hereinafter, an exemplary application of this preferred embodiment will be described with reference to FIGS. 6 and 7.

Recently, digital broadcast receivers have become increasingly popular. As a result, it is not uncommon that a single household has multiple receivers of that type. And such a trend is expected to further increase in the future.

Meanwhile, mobile devices such as cellphones have become so popular nowadays that it is no longer rare that there are two or more mobile devices per household. Thus, a content providing system that can cope with even such a situation will be described.

FIG. 6 shows a configuration for a modified content providing system. This content providing system includes a plurality of digital broadcast receivers 101a and 101b and a plurality of mobile terminals 102a, 102b, 102c and 102d. The receivers 101a and 101b are supposed to be installed in a single house, for example. Also, each of the receivers 101a and 101b is supposed to have the same function and the same configuration as the receiver 101 shown in FIG. 2 as a matter of principle except for a number of functions to be mentioned specifically later.

The content providing system shown in FIG. 6 further includes a broadcaster 103 with a content database 111 and a seller 104. The broadcaster 103 and the seller 104 are also supposed to have the same functions and the same configurations as the counterparts shown in FIG. 1 as a matter of principle except for some functions to be mentioned specifically later.

In this content providing system, the user can use a content under a contract with the seller 104. The contract may read “a content should be shared by a number N of mobile terminals, each having its own mobile terminal ID number, by using digital broadcast receivers, each having a particular device ID”, for example. Hereinafter, specific contents of the contract will be described as an example. It should be noted that the content to use by contract is supposed to be identified by a content ID under the contract.

First, the receiver 101a performs the content purchasing and settlement processing step shown in FIG. 3. More specifically, the authenticating section 204 of the receiver 101a communicates with the seller 104 over the Internet and provides the personal information that has been entered by the user for the seller 104.

The authenticating section 204 submits not only these pieces of information but also the device ID number of the receiver 10a (which is supposed to be “DMR 1110” in this example), stored in the ID number memory 205, to the seller 104 and gets registered with the seller 104. In addition, the authenticating section 204 further submits the respective mobile terminal ID numbers of the mobile terminals 102a and 102b (which are supposed to be “090-0000-0001” and “090-0000-0003”, respectively) to the seller 104 and gets the mobile terminals 102a and 102b registered with the seller 104. After having authenticated the user and the device, the seller 104 transmits the content ID and content key of the requested content to the receiver 101. In response, the authenticating section 204 stores the content ID and content key in the key memory 203. As a result, the content is downloaded from the receiver 101a and can be used only in the two mobile terminals 102a and 102b.

In the ID number memory 205 of the receiver 101a, stored are the respective mobile terminal ID numbers of the mobile terminals 102a and 102b.

Next, the user accesses the seller 104 by way of the other receiver 101b and submits the device ID of the receiver 101b (which is supposed to be “DMR 1120”) to the seller 104. Furthermore, the user also submits the mobile terminal ID number of the mobile terminal 102c (which is supposed to be “090-0000-0002”) to the seller 104 and can get the mobile terminal 102c registered with the seller 104. As a result, the content is downloaded from the receiver 101b and can be used only in the mobile terminal 102c. If the user wants to use the content at the mobile terminal 102d, then its mobile terminal ID number may be submitted. In the ID number memory 205 of the receiver 101b, the mobile terminal ID number of the mobile terminal 102c is stored.

As a result of the registration process described above, the device ID authenticating section 122 of the seller 104 compiles and retains a table of correspondence between the mobile terminal ID numbers and the device ID numbers. FIG. 7 shows a table of correspondence that was compiled and retained in the device ID authenticating section 122. It will be described later how to carry out a process by using this table of correspondence.

The processing step of getting a content from a data channel on digital broadcasting may be carried out just as described above. If the content ID of the content that has been transmitted over the data channel on the digital broadcasting is identical to one of the content IDs stored in the key memory 203, the data (i.e., the content) on that data channel is gotten. In getting the content, there is no need for the user to go through any special getting operation.

According to the digital broadcasting, a content is distributed by the “push” technology. That is to say, when a predetermined amount of time passes after the user signed a contract, the content will have been downloaded automatically and will be available. The user can easily know when his or her desired content will be distributed by looking at an electronic program guide of digital broadcasting, for example.

The pushing distribution is advantageous in that even when a content is upgraded (i.e., even when a content of the newest version is released), the user can always use that newest content. Once effected a contract, the user does not have to go through any procedure of getting or updating a content.

It should be noted that if the user is going to purchase a content by using a PC, for example, then the content will not be distributed unless requested by the user. That is to say, content distribution using a PC is a “pulling” distribution. In that case, the user needs to look for his or her desired content and perform a series of operations to get the distribution done. That is why the content distribution by digital broadcasting is very user-friendly.

The processing step of transmitting a content to a mobile terminal is also carried out just as described above. The content is transmitted to the mobile terminal mainly by following the procedure shown in FIG. 5. As described above, the mobile terminal ID numbers of the mobile terminals under contracts with the seller 104 are stored in the respective ID number memories 205 in the receivers 101a and 101b. Thus, each terminal communication section 210 needs to determine, by reference to its associated ID number memory 205, whether or not the mobile terminal ID number gotten is identical to a stored number.

In the preferred embodiment described above, the mobile terminal 102 and the receiver 101 can both make bidirectional communications with each other. That is why after the user has played a game halfway through on the mobile terminal 102, he or she may transmit the content related information, including the content ID, to the receiver 101.

For example, if the mobile terminal 102 sends history information about the stage or score of the game, the receiver 101 can store the history information in the content memory 206. And if either the receiver 101 or the mobile terminal 102 refers to the history information when the game is resumed, the user can restart the game from where he or she stopped.

The receiver 101 and the seller 104 can also make bidirectional communications with each other. That is why the history information that has been transmitted to the receiver 101 may be forwarded to the server 123 of the seller 104. By reference to that history information, the seller 104 can know the total score or the highest score of that game content on a terminal ID basis. For example, if the seller 104 lays open the statistical data by using the responding server 123, then the user can know his or her standing at any time.

Furthermore, the seller 104 can also determine, by reference to the history information, whether or not to provide a new content for the user. As used herein, the “new content” may refer to either a content that is one step more advanced than the content that the user has got through or a content with the next story.

However, the seller 104 needs to reject the history information that has been transmitted from non-registered users who are not allowed to use the content. Thus, first, the seller 104 makes the receiver 101 refuse to receive the history information.

More specifically, the network communicating section 211 of the receiver 101 may refuse to receive the history information that has been transmitted from a mobile terminal, of which the number is not stored in the ID number memory 205. On the other hand, if the number of that mobile terminal is stored in the ID number memory 205, the network communicating section 211 refers to the table of correspondence between the mobile terminal ID numbers and the contents' ID numbers in the key memory 203 to see if the mobile terminal ID number and the content ID of the content associated with the history information are included in the table of correspondence.

Then, the device ID authenticating section 122 of the seller 104 may have the receiver 101 send the device ID number of that receiver 101 and the mobile terminal ID number along with the history information. In this case, the “mobile terminal ID number” refers to the ID number of the mobile terminal that has transmitted its history information to the receiver 101.

The device ID authenticating section 122 of the seller 104 determines whether or not the device ID and mobile terminal ID numbers transmitted are included in the table of correspondence shown in FIG. 7. If the answer is YES, then the request is processed as the history information of a legitimate registered user. Otherwise, such history information may be discarded.

As described above, content information may be exchanged only between the seller 104 and the registered mobile terminal 102 via the receiver 101, thus realizing a new content providing method.

It should be noted that the contents of the contract signed by the user with the seller 104 are just an example. Thus, the contract may have any other contents. For example, a contract may be written such that a content should be shared by a number N of mobile terminals by using a digital broadcast receiver with a particular device ID. According to such a contract, not the mobile terminal ID numbers of the mobile terminals that are going to use the content but only the number of those mobile terminals is controlled.

The receiver 101 includes a counter to show the maximum allowable number of times a given content can be transmitted. The counter value is decremented every time the content is downloaded to a mobile terminal. And when the value goes zero, the transmission of that content may be prohibited.

To output a content in this manner is sometimes called a “checkout”. Optionally, the user can send back the “checked-out” content to the receiver 101 that transmitted it to him or her. Then, the content that has been executable on the mobile terminal becomes no longer available. This procedure is called a “check-in”. Every time a check-in is done, the counter value is incremented by one.

In the preferred embodiment shown in FIG. 6, the receiver 101a is supposed to submit the ID numbers of the mobile terminals 102a and 102b to the seller 104 and get them registered with the seller 104. However, the device to be registered does not have to be a mobile terminal but may also be the receiver 101b or even a fixed device with no digital broadcast receiving function. In any case, the content is executed on a registered device.

According to this preferred embodiment, when a content is about to be transferred from the receiver 101 to the mobile terminal 102, the receiver 101 determines, by the ID number of the mobile terminal, whether or not the content may be transferred to the mobile terminal. Thus, it is possible to prevent a third party, not the viewer who purchased the content through the digital broadcast receiver, from receiving the content at his or her mobile terminal illegally.

In the preferred embodiment described above, infrared communications are supposed to be exchanged between the receiver 101 and the mobile terminal 102. Alternatively, the receiver 101 and the mobile terminal 102 may be directly connected together via a cable. As another alternative, radio communications other than the infrared communications may be exchanged between them.

Also, in the preferred embodiment described above, the receiver 101 is supposed to have multiple types of memories including the key memory 203, the ID number memory 205 and the content memory 206. However, these memories may be physically implemented as a single memory.

Furthermore, the preferred embodiment described above relates to transmission from the receiver 101 to the mobile terminal 102. However, transmission from the mobile terminal 102 to the receiver 101 may also be carried out in a similar manner. This type of transmission is effective if the user is operating some device that is easier to handle than the mobile terminal 102 and if he or she wants to enjoy a content on a larger screen. The processing of transmitting a content from the mobile terminal 102 to the receiver 101 may be carried out in the following manner. First, by performing the same processing steps as Steps S501 and S502 shown in FIG. 5, the receiver 101 gets the mobile terminal ID number of the mobile terminal 102 and refers to the ID number memory 205 to determine whether or not the mobile terminal ID number is stored in the memory 205. And only when the mobile terminal ID number is stored, the receiver 101 receives the content that has been transmitted from the mobile terminal 102. Then, the receiver 101 executes the received content in accordance with the user's instruction. As a result, the user can enjoy the content on a display screen of a relatively big size by using the remote controller of the receiver 101, which is easier to handle than the mobile terminal. In addition, it is also possible to prevent a non-registered mobile terminal user from playing the content using the receiver 101.

The receiver 101 performs the processing described above by executing a computer program, which may include instructions to carry out the processing that is defined by the flowcharts shown in FIGS. 3 and 5. The computer program may be stored in any of various types of storage media. Examples of preferred storage media include optical storage media such as optical disks, semiconductor storage media such as an SD memory card and an EEPROM, and magnetic recording media such as a flexible disk.

### INDUSTRIAL APPLICABILITY

According to the present invention, a content to enjoy on a mobile terminal can be gotten by operating a digital broadcast receiver. There is no need to access the responding server of a content seller a number of times, thus cutting down the telecommunications fees. In addition, the content gotten can be transmitted to, and received from, the mobile terminal securely.

1. A digital broadcast receiver for transmitting content data to at least one external terminal with a unique terminal ID, the receiver comprising:
a receiving section for receiving a digital broadcasting wave;
a getting section for getting content data from the digital broadcasting wave;
a memory in which the terminal IDs of one or more external terminals have been stored in advance; and
a communication section for communicating with the external terminal and getting the unique terminal ID of the external terminal,
wherein the communication section determines whether or not the terminal ID gotten is identical to any of the terminal IDs stored in the memory, and if those IDs are identical with each other, the communication section transmits the content data to the external terminal.

2. The digital broadcast receiver of claim 1, wherein if the terminal ID gotten is not identical to any of the terminal IDs stored in the memory, the communication section controls the transmission of the content to the external terminal.

3. The digital broadcast receiver of claim 1, wherein the memory stores a content ID that identifies a transmittable content in association with the terminal ID of each of the one or more external terminals, and
wherein the communication section gets the terminal ID of the external terminal on the receiving end before transmitting the content thereto, and
wherein if the content ID of the content to be transmitted and the terminal ID are associated with each other in the memory, the communication section transmits the content to the external terminal.

4. The digital broadcast receiver of claim 3, wherein if the content ID of the content to be transmitted and the terminal ID are not associated with each other in the memory, the communication section controls the transmission of the content to the external terminal.

5. The digital broadcast receiver of claim 1, further comprising:
a network communicating section for communicating with a server of the seller of the content; and
a decrypting section for decrypting an encrypted content,
wherein the network communicating section transmits contract information, which has been entered by a user, to the server and receives key data to decode the content from the server, the key data having been provided based on the contract information, and
wherein the getting section gets encrypted content data, and
wherein the decrypting section decrypts the encrypted content with the key data.

6. The digital broadcast receiver of claim 5, wherein the getting section gets the content data from the digital broadcasting wave by reference to the content ID of the content that the user has agreed to purchase.

7. The digital broadcast receiver of claim 1, further comprising a network communicating section for communicating with a server of the seller of the content,
wherein the communication section receives the content related information from the external terminal, and
wherein the network communicating section transmits the received information to the server.

8. The digital broadcast receiver of claim 7, wherein if the terminal ID gotten is identical to any of the terminal IDs stored in the memory, the communication section receives the information from the external terminal.

9. The digital broadcast receiver of claim 8, wherein if the content ID of the content, about which the information has been provided, and the terminal ID are further associated with each other in the memory, the communication section receives the information from the external terminal.

10. The digital broadcast receiver of claim 1, further comprising a network communicating section for communicating with a server of the seller of the content,
wherein the memory further stores the unique device ID of the digital broadcast receiver, and
wherein the network communicating section transmits contract information, which has been entered by a user, and the device ID to the server, and saves a content ID that has been sent from the server responsive to authentication of the contract information and the device ID.

11. The digital broadcast receiver of claim 10, wherein the getting section gets the content data from the digital broadcasting wave by reference to the content ID saved.

12. A data transmitting method to be carried out by a digital broadcast receiver with a unique device ID, the method comprising the steps of:
transmitting contract information, which has been entered by a user, and the device ID to a server of a content seller;
saving a content ID that has been sent from the server responsive to authentication of the contract information and the device ID;
getting content data from a digital broadcasting wave by reference to the content ID saved;
storing the terminal IDs of one or more external terminals;
communicating with an external terminal to get the unique terminal ID of the external terminal; and
determining whether or not the terminal ID gotten is identical to any of the terminal IDs stored in the memory and transmitting the content data to the external terminal if the terminal IDs are identical with each other.
